(19) United States
(12) Patent Application Publication
(10) Pub. No.: US 2025/0209725 A1
(43) Pub. Date: Jun. 26, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Tomokazu SATO, Tokyo (JP)

(21) Appl. No.: 18/940,985

(22) Filed: Nov. 8, 2024

(30) Foreign Application Priority Data
Dec. 21, 2023 (JP) 2023-215803

(51) Int. Cl. G06T 15/06; G06T 15/20

(52) U.S. Cl. CPC G06T 15/06; G06T 15/20

(57) ABSTRACT

A three-dimensional field corresponding to an object, which is used in a case where a virtual viewpoint image is generated, is estimated with high accuracy. The image processing apparatus according to the present disclosure obtains data of a plurality of captured images obtained by image capturing from a plurality of viewpoints, obtains an object area corresponding to a representation of an object in each of the plurality of captured images, sets a learning ray group that is used for learning of information relating to a three-dimensional field of an image capturing space that is an image capturing target from the plurality of viewpoints, and which corresponds to pixels of each of the plurality of captured images based on the obtained object area, and performs learning of information relating to the three-dimensional field based on the set learning ray group.

### BACKGROUND

### Field

The present disclosure relates to an image processing technique for generating an image corresponding to a representation in a case of being viewed from an arbitrary virtual viewpoint by using a plurality of captured images obtained by image capturing from a plurality of positions different from one another.

### Description of the Related Art

There is a technique to generate an image corresponding to a representation in a case of being viewed from an arbitrary virtual viewpoint by using a plurality of captured images (in the following, called “multi-viewpoint images”) obtained by image capturing of imaging apparatuses whose camera parameters are already known, which are arranged at each of a plurality of positions different from one another. In the following, explanation is given by referring to an image corresponding to a representation in a case of being viewed from a virtual viewpoint as “virtual viewpoint image”. U.S. patent Ser. No. 11/308,659 (in the following, called “Patent Document 1”) has disclosed a technique called NeRF (Neural Radiance Fields) as a technique to generate a virtual viewpoint image corresponding to an arbitrary virtual viewpoint by taking the data of multi-viewpoint images (in the following, called “multi-viewpoint image data”) as an input. The technique called NeRF disclosed in Patent Document 1 includes a neural network and volume rendering. Specifically, the neural network of the NeRF takes the data of a plurality of captured images (in the following, called “captured image data”) configuring multi-viewpoint image data as an input and outputs information indicating density and color at an arbitrary position and in an arbitrary direction. Further, the volume rendering of the NeRF calculates a pixel value by accumulating the color obtained from a sampling point on a ray corresponding to a pixel in a virtual viewpoint image in accordance with density.

The neural network of the NeRF is learned by taking the pixel value of multi-viewpoint image as training data and adjusting network parameters so that the difference (loss) between the pixel value of multi-viewpoint images and the pixel value that is calculated by the NeRF becomes small. Generally, in the learning of the neural network of the NeRF, minibatch learning is adopted in which the ray corresponding to the pixel in a captured image is sampled randomly and learning is repeated by taking this as one learning unit (in the following, called “minibatch”). According to the minibatch learning, compared to the batch learning in which all the rays are learned at one time, it is possible to reduce the memory usage relating to a VRAM (Video Random Access Memory). Further, in the minibatch learning, it is possible to perform stepwise learning, and therefore, it is considered that the minibatch learning is indispensable to the execution of the learning of a neural network in the technique relating to the NeRF.

### SUMMARY

With the technique disclosed in Patent Document 1 (in the following, called “prior art”), in a case where the occupied area ratio of an object that is taken as a target (in the following, simply called “object”) for the viewing angle of a captured image is small, it may happen sometimes that the estimation of the object fails. The object estimation failure referred to here means that, for example, part or all of the image corresponding to the object disappears in a virtual viewpoint image. The object estimation failure such as this results from that the ray representing the object is not included in the minibatch. On the other hand, in a case where the occupied area ratio of the object is large for the viewing angle of the captured image, it may happen sometimes that an artifact, such as a fog called floater, occurs around the image corresponding to the object in the virtual viewpoint image.

The image processing apparatus according to the present disclosure includes: one or more hardware processors; and one or more memories storing one or more programs configured to be executed by the one or more hardware processors, the one or more programs including instructions for: obtaining data of a plurality of captured images obtained by image capturing from a plurality of viewpoints; obtaining an object area corresponding to a representation of an object in each of the plurality of captured images; setting a learning ray group corresponding to pixels of each of the plurality of captured images, which is used for learning of information relating to a three-dimensional field of an image capturing space that is an image capturing target from the plurality of viewpoints, based on the obtained object area; and performing learning of information relating to the three-dimensional field based on the set learning ray group.

Further features of the present disclosure will become apparent from the following description of exemplary embodiments with reference to the attached drawings.

### BRIEF DESCRIPTION OF THE DRAWINGS

FIG. 1 is a diagram showing one example of a configuration of an image processing system according to Embodiment 1;

FIG. 2 is a block diagram showing one example of a hardware configuration of an image processing apparatus according to Embodiment 1;

FIG. 3A and FIG. 3B are each a diagram for explaining a cause of a problematic point that occurs in the prior art;

FIG. 4A and FIG. 4B are each a diagram for explaining a cause of a problematic point that occurs in the prior art;

FIG. 5A and FIG. 5B are each a block diagram showing one example of a function configuration of the image processing apparatus according to Embodiment 1;

FIG. 6A to FIG. 6C are each a flowchart showing one example of a processing flow of the image processing apparatus according to Embodiment 1;

FIG. 7A to FIG. 7C are each a diagram for explaining processing of the flowchart shown in FIG. 6A;

FIG. 8 is a diagram showing one example of a flow of sampling of data of an object ray included in an object ray list according to Embodiment 1;

FIG. 9 is a block diagram showing one example of a function configuration of an image processing apparatus according to Embodiment 2;

FIG. 10 is a flowchart showing one example of a processing flow in a learning phase of the image processing apparatus according to Embodiment 2;

FIG. 11A to FIG. 11D are each a diagram for explaining processing of the flowchart shown in FIG. 10; and

FIG. 12A and FIG. 12B are each a flowchart showing one example of a processing flow of an image processing apparatus according to Embodiment 3.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

Further, all combinations of features explained in the embodiments are not necessarily indispensable to the solution of the present disclosure. In the following embodiments, explanation is given by describing a two-dimensional area on an image simply as “area” and a three-dimensional area in an image capturing space simply as “space”.

### Embodiment 1

### <Configuration of Image Processing System>

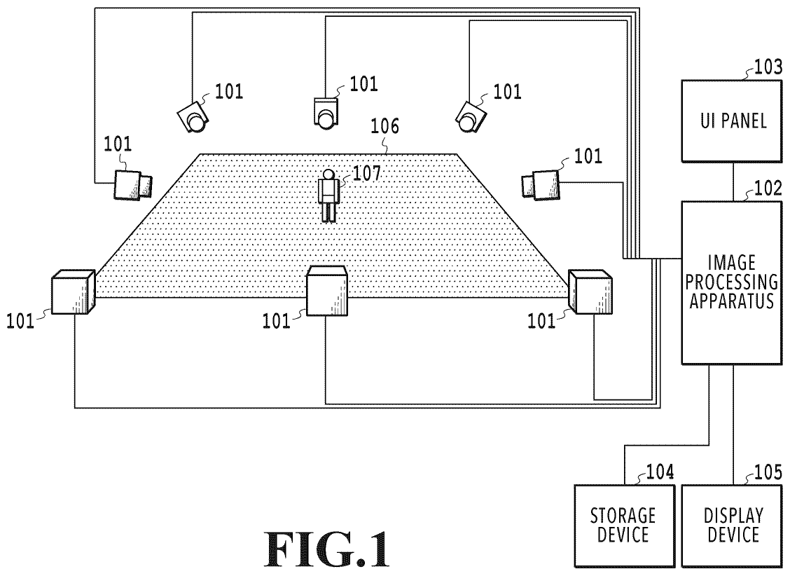

FIG. 1 is a diagram showing one example of the configuration of an image processing system according to Embodiment 1. The image processing system has a plurality of imaging apparatuses 101, an image processing apparatus 102, a user interface (in the following, described as “UI”) panel 103, a storage device 104, and a display device 105. The plurality of the imaging apparatuses 101 includes digital still cameras, digital video cameras or the like and is arranged at positions different from one another. Each imaging apparatus 101 captures an object 107 existing in an image capturing space 106 in synchronization with one another in accordance with image capturing conditions determined in advance and outputs captured image data obtained by the image capturing to the image processing apparatus 102. The captured image data that is obtained by the image capturing of the imaging apparatus 101 may be data of a still image, data of a moving image, or data of both still image and moving image. In the following, explanation is given by supposing that the word “image” includes the meaning of both “still image” and “moving image” unless described particularly.

The image processing apparatus 102 obtains a plurality of pieces of captured image data (multi-viewpoint image data) that is output from the plurality of the imaging apparatuses 101 and performs learning of a three-dimensional field corresponding to the object 107 within the image capturing space, based on the obtained multi-viewpoint image data. Further, the image processing apparatus 102 may perform control for each of the plurality of the imaging apparatuses 101. The learning-target three-dimensional field within the image capturing space is different in accordance with learning contents. In Embodiment 1, as one example, explanation is given on the assumption that the learning-target three-dimensional field is radiance fields.

The UI panel 103 comprises a display device, such as a liquid crystal display, and displays a user interface for presenting image capturing conditions for the imaging apparatus 101, processing settings of the image processing apparatus 102, and the like on the display device. The UI panel 103 may comprise an input device, such as a touch panel, a button or the like and in this case, the UI panel 103 receives instructions from a user, which relate to changes in the image capturing conditions, the processing settings and the like described above. The input device may be provided separately from the UI panel 103 like a mouse, a keyboard or the like.

The storage device 104 includes a hard disk drive or the like and stores information relating to the three-dimensional field corresponding to the object 107, which the image processing apparatus 102 outputs. The display device 105 includes a liquid crystal display or the like, obtains an image signal that is output from the image processing apparatus 102 and indicates the three-dimensional field corresponding to the object 107, and displays an image corresponding to the image signal. Further, the display device 105 may obtain an image signal that is output from the image processing apparatus 102 and indicates a virtual viewpoint image, and may display a virtual viewpoint image corresponding to the image signal. The image capturing space 106 is a three-dimensional space surrounded by a plurality of the imaging apparatuses 101 arranged in a studio or the like and the frame indicated by a solid line in FIG. 1 indicates the contour of the image capturing space 106 on the floor surface.

### <Hardware Configuration of Image Processing Apparatus>

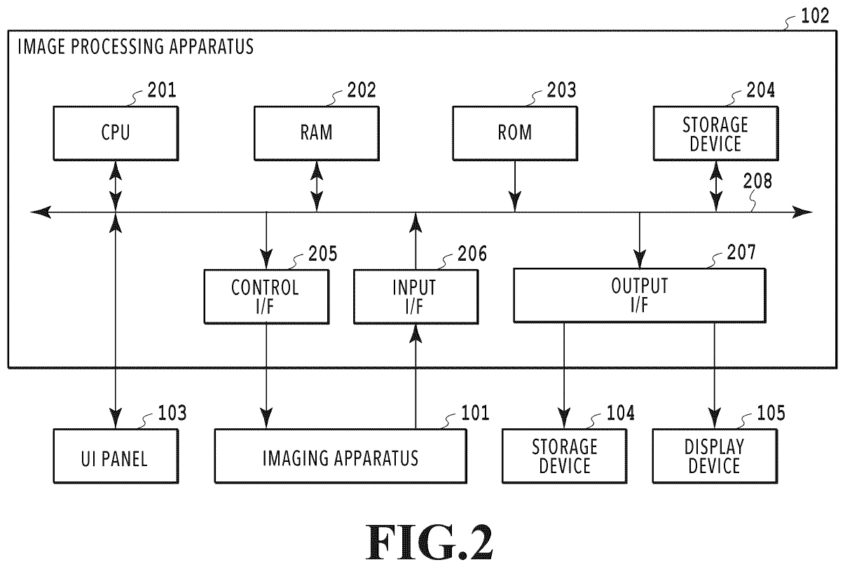

FIG. 2 is a block diagram showing one example of the hardware configuration of the image processing apparatus 102 according to Embodiment 1. The image processing apparatus 102 has, as hardware configurations, a CPU 201, a RAM 202, a ROM 203, a storage device 204, a control interface (in the following, described as “I/F”) 205, an input I/F 206, an output I/F 207, and a main bus 208. The CPU 201 is a processor comprehensively controlling each unit of the image processing apparatus 102. The RAM 202 functions as a main memory, a work area and the like of the CPU 201. The ROM 203 stores one or more programs that are executed by the CPU 201. The storage device 204 includes a hard disk drive or the like and stores application programs that are executed by the CPU 201, data that is used for the processing of the CPU 201, and the like.

The control I/F 205 is connected with each imaging apparatus 101 and is a communication interface for performing control, such as the setting of image capturing conditions and the start and stop of image capturing, for each imaging apparatus 101. The input I/F 206 is a communication interface by a serial bus, such as SDI (Serial Digital Interface) or HDMI (registered trademark) (High-Definition Multimedia Interface (registered trademark)). Via the input I/F 206, the captured image data that is output from each imaging apparatus 101 is obtained. The output I/F 207 is a communication interface by a serial bus, such as USB (Universal Serial Bus) or IEEE (Institute of Electrical and Electronics Engineers) 1394. Via the output I/F 207, data or a signal indicating the shape of the object 107 is output to the storage device 104 or the display device 105. The main bus 208 is a transmission path that connects the above-described hardware configurations of the image processing apparatus 102 to one another so that communication is possible.

In Embodiment 1, as one example, an aspect is explained in which one or a plurality of objects existing within a studio is captured from a plurality of viewpoints by using the eight imaging apparatuses 101 arranged in the studio. Further, it is assumed that camera parameters of each imaging apparatus 101, such as intrinsic parameters, extrinsic parameters, and distortion parameters, are stored in advance in the storage device 204. The intrinsic parameters are information indicating the coordinates corresponding to the center pixel in a captured image that is obtained by image capturing of the imaging apparatus 101, the focal length of the lens of the imaging apparatus 101, and the like. The extrinsic parameters are information indicating the position, orientation and the like of the imaging apparatus 101. The camera parameters of each imaging apparatus 101 are not required to be common to one another and for example, the viewing angle of the imaging apparatus 101 may be different from the viewing angle of another imaging apparatus 101.

### <Explanation of Cause>

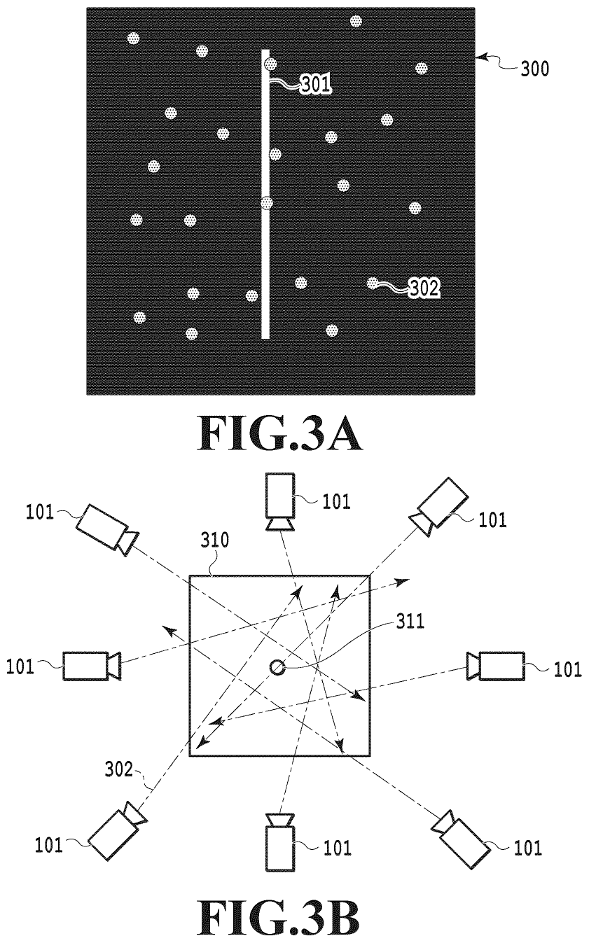

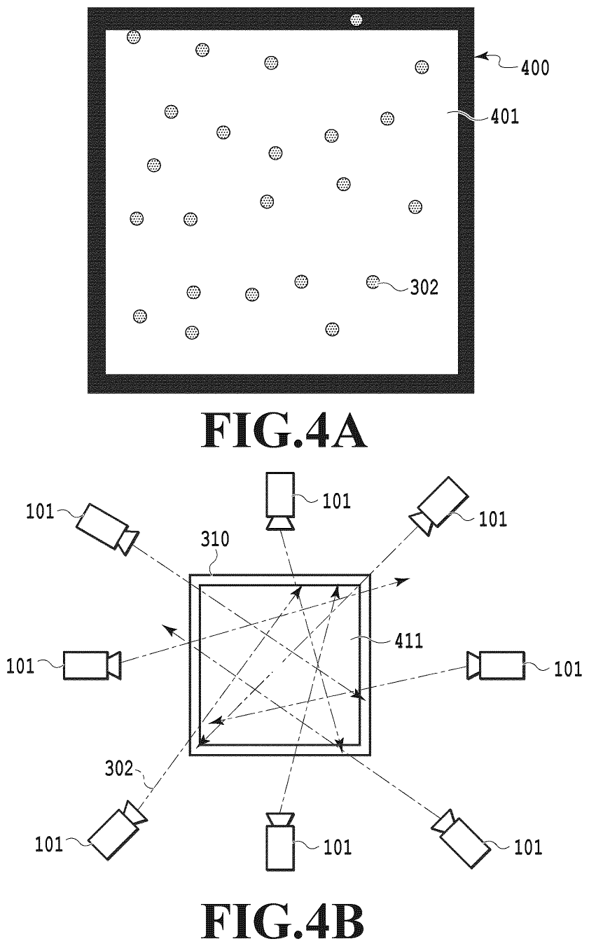

Before Embodiment 1 is explained specifically, the cause of the problematic point that occurs in the prior art is explained with reference to FIG. 3A to FIG. 4B. FIG. 3A and FIG. 3B are each a diagram for explaining the cause of the problematic point that occurs in the prior art and is a diagram showing one example of the way sampling of rays is in a case where learning of a three-dimensional field corresponding to a thin rod-shaped object 311 is performed by using the prior art. Specifically, FIG. 3A shows one example of a captured image 300 that is obtained by image capturing from a certain viewpoint. FIG. 3B shows one example of a relationship between the object 311 and rays 302 and also shows one example of a relationship between the object 311 and the rays in a case where the image capturing space 106 that is captured by the imaging apparatus 101 is viewed from above in the vertical direction. The captured image 300 includes an image 301 corresponding to the object 311. The rays 302 shown in FIG. 3A is not included in the captured image 300 as an image but explicitly indicates one example of the corresponding position in the captured image 300 for each ray 302 shown in FIG. 3B.

For example, in a case where the object 311 is the shape of a thin rod, the occupied area ratio of the object 311 in the viewing angle of the imaging apparatus 101 becomes low. Because of that, the number of samplings of the rays 302 corresponding to the pixel included in the area of the object 311 decreases. As a result, despite the space corresponding to the object 311, there is a case where it is learned as a space including nothing, that is, as a space in which the object 311 does not exist.

On the other hand, FIG. 4A and FIG. 4B are each a diagram for explaining the cause of the problematic point that occurs in the prior art and a diagram showing one example of the way sampling of rays is in a case where learning of a three-dimensional field corresponding to a big box-shaped object 411 is performed. Specifically, FIG. 4A shows one example of a captured image 400 that is obtained by image capturing from a certain viewpoint. Further, FIG. 4B shows one example of a relationship between the object 411 and the rays 302 and shows one example of a relationship between the object 411 and the rays 302 in a case where the image capturing space 106 that is captured by the imaging apparatus 101 is viewed from above in the vertical direction. The captured image 400 includes an image 401 corresponding to the object 411. The rays 302 shown in FIG. 4A is not included in the captured image 400 as an image but explicitly indicates one example of the corresponding position in the captured image 400 of each ray 302 shown in FIG. 4B.

In a case where the object 411 is the shape of a big box, the occupied area ratio of the object 411 in the viewing angle of the imaging apparatus 101 becomes high. Because of that, the number of samplings of the rays 302 corresponding to the pixel included in the area (in the following, “non-object area”) other than the area of the image 401 corresponding to the object 411 decreases. As a result, the learning of the space in which the object 411 does not exist is insufficient, and therefore, there is a case where an artifact, such as a fog called floater, occurs around the image corresponding to the object 411 in the generated virtual viewpoint image.

### <Function Configuration of Image Processing Apparatus>

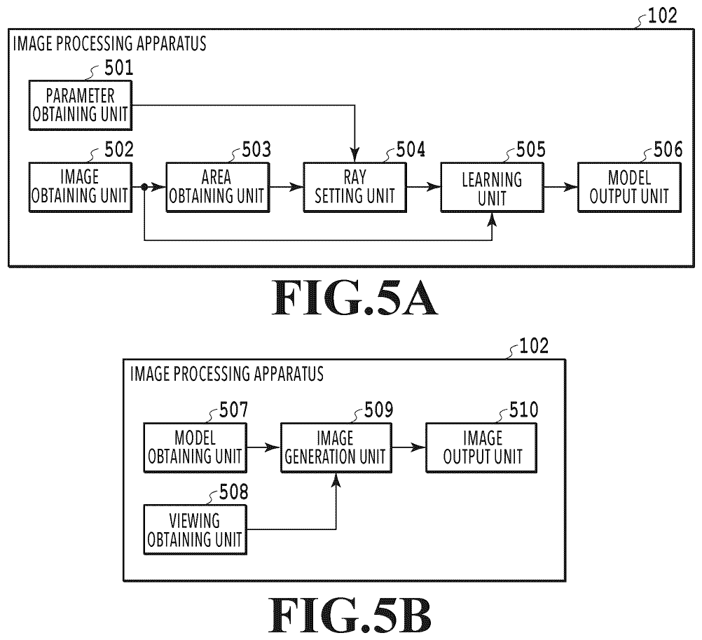

With reference to FIG. 5A and FIG. 5B, the function configuration of the image processing apparatus 102 is explained. FIG. 5A and FIG. 5B are each a block diagram showing one example of the function configuration of the image processing apparatus 102 according to Embodiment 1. Specifically, FIG. 5A shows one example of the function configuration in the learning phase of the image processing apparatus 102 and FIG. 5B shows one example of the function configuration in the generation phase of the image processing apparatus 102. As shown in FIG. 5A, for example, the image processing apparatus 102 has, as function configurations in the learning phase, a parameter obtaining unit 501, an image obtaining unit 502, an area obtaining unit 503, a ray setting unit 504, a learning unit 505, and a model output unit 506 Further, as shown in FIG. 5B, the image processing apparatus 102 has, as function configurations in the generation phase, a model obtaining unit 507, a viewing obtaining unit 508, an image generation unit 509, and an image output unit 510. Each unit the image processing apparatus 102 has as a function configuration is implemented by the CPU 201 shown in FIG. 2 executing a program stored in the ROM 203.

The parameter obtaining unit 501 obtains parameters for learning (in the following, called “learning parameters”). The learning parameters are stored in advance in, for example, the storage device 204 and the parameter obtaining unit 501 obtains the learning parameters by reading them from the storage device 204. The learning parameters obtained by the parameter obtaining unit 501 are transmitted to the ray setting unit 504. The image obtaining unit 502 obtains captured image data. Specifically, for example, the image obtaining unit 502 obtains captured image data, which is output from each imaging apparatus 101, via the input I/F 206. The captured image data obtained by the image obtaining unit 502 is transmitted to the area obtaining unit 503 and the learning unit 505. The area obtaining unit 503 obtains the object area in each captured image by extracting them corresponding to the representation of the object 107 in each of the plurality of captured images received from the image obtaining unit 502. The area obtaining unit 503 outputs information indicating the obtained object area as an object area map. The object area map output from the area obtaining unit 503 is obtained by the ray setting unit 504.

The ray setting unit 504 sets a group (in the following, called “learning ray group”) of rays that are used for the learning (in the following, called “learning rays”) of a three-dimensional field of an image capturing space based the learning parameters received from the parameter obtaining unit 501 and the object area map obtained from the area obtaining unit 503. The learning unit 505 performs the learning of a learning model representing the three-dimensional field of the image capturing space by using the data of the learning ray group set by the ray setting unit 504 and the captured image data transmitted from the image obtaining unit 502. The model output unit 506 outputs a learned model representing the three-dimensional field of the image capturing space, which is obtained as the results of the learning by the learning unit 505. Specifically, for example, the model output unit 506 outputs the learned model to the storage device 204 or the storage device 104 and causes the storage device 204 or the storage device 104 to store the learned model. Information relating to the learned model is, for example, network parameters of the learned model.

The model obtaining unit 507 obtains the learned model by reading it from the storage device 204, the storage device 104 or the like. The learned model obtained by the model obtaining unit 507 is transmitted to the image generation unit 509. The viewing obtaining unit 508 obtains information (in the following, called “virtual viewpoint information”) indicating the position of a virtual viewpoint, the viewing direction at a virtual viewpoint and the like. The virtual viewpoint information is stored in advance in, for example, the storage device 204 and the viewing obtaining unit 508 obtains the virtual viewpoint information by reading it from the storage device 204. The virtual viewpoint information may be obtained by the viewing obtaining unit 508 generating it based on the input from a user using the UI panel 103. The virtual viewpoint information may be information also called the so-called virtual camera path including the time-series data of the position of a virtual viewpoint, the viewing direction at the virtual viewpoint or the like. The virtual viewpoint information obtained by the viewing obtaining unit 508 is sent to the image generation unit 509.

The image generation unit 509 receives the learned model that is transmitted from the model obtaining unit 507 and the virtual viewpoint information that is transmitted from the viewing obtaining unit 508 and generates a virtual viewpoint image by using the learned model and the virtual viewpoint information, which are received. The method of generating a virtual viewpoint image by using the learned model representing the three-dimensional field of the image capturing space and the virtual viewpoint information is the same as the generation method of a virtual viewpoint image by the conventional NeRF, and therefore, explanation thereof is omitted. The image output unit 510 outputs the virtual viewpoint image generated by the image generation unit 509. Specifically, for example, the image output unit 510 outputs the data of the virtual viewpoint image to the storage device 204 or the storage device 104 and causes the storage device 204 or the storage device 104 to store the data. The output destination of the image output unit 510 is not limited to the storage device 204 or the storage device 104 and for example, the output destination may be the display device 105. In this case, the image output unit 510 operates as a display control unit for outputting the image signal indicating the virtual viewpoint image to the display device 105 and causing the display device 105 to display the virtual viewpoint image.

### <Operation in Learning Phase of Image Processing Apparatus>

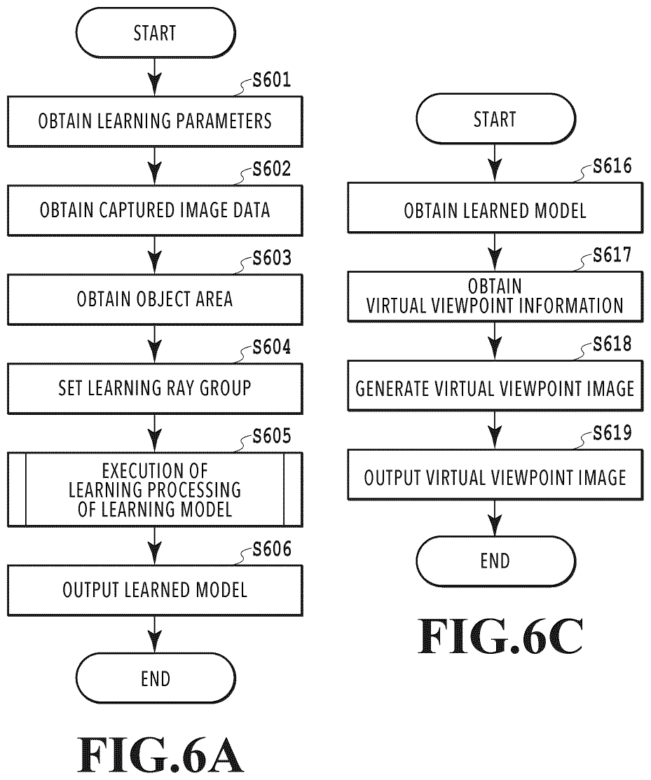

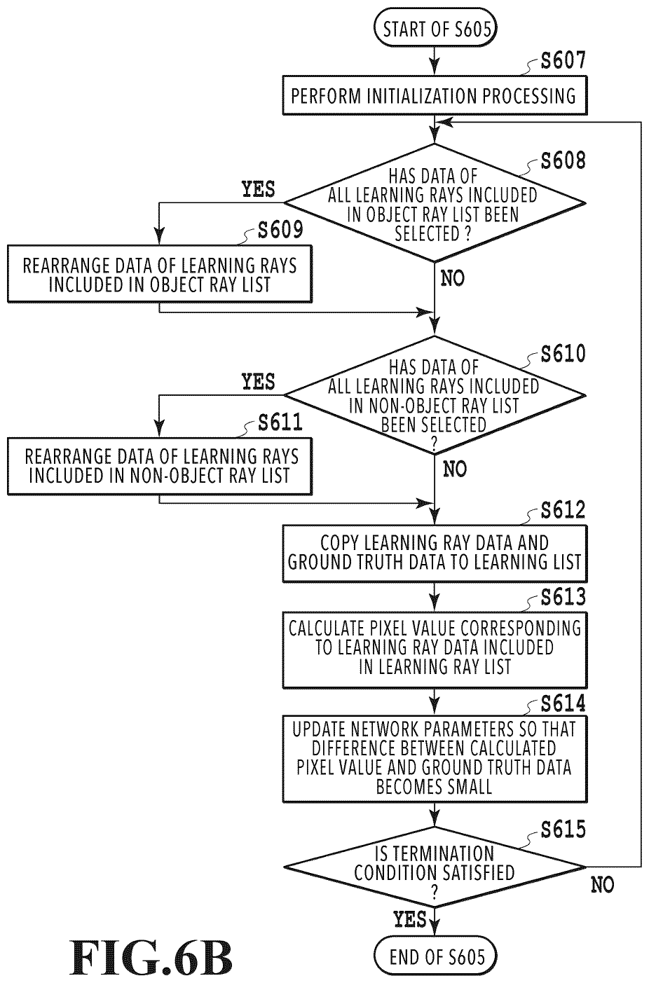

With reference to FIG. 6A to FIG. 6C, the operation of the image processing apparatus 102 is explained. FIG. 6A to FIG. 6C are each a flowchart showing one example of a processing flow of the image processing apparatus 102 according to Embodiment 1. Specifically, FIG. 6A and FIG. 6B each show one example of a processing flow in the learning phase of the image processing apparatus 102 and FIG. 6C shows one example of a processing flow in the generation phase of the image processing apparatus 102. “S” attached to the top of the symbol means a step. The processing at each step shown in the flowcharts in FIG. 6A to FIG. 6C is implemented by the CPU 201 reading a predetermined program from the ROM 203 or the storage device 204, loading the program onto the RAM 202, and executing the program. Further, in a case where the captured image data that is input to the image processing apparatus 102 is the data of a moving image, the processing at each step shown in the flowcharts in FIG. 6A to FIG. 6C is performed for each frame configuring the moving image.

First, with reference to FIG. 6A and FIG. 6B, the processing flow in the learning phase of the image processing apparatus 102 is explained. In the learning phase, first, at S601, the parameter obtaining unit 501 obtains learning parameters. Specifically, the parameter obtaining unit 501 obtains, as learning parameters, a number of learning rays (Nr), which is the learning unit (size of minibatch), and a number of object rays (Nf), which is the number of learning rays corresponding to the object area in the number of learning rays (Nr). Practically, the learning unit is set to about 4,096 in many cases. In Embodiment 1, explanation is given on the assumption that the number of learning rays (Nr) is 4,096 and the number of object rays (Nf) is 2,048. However, these values are hyper parameters designated in advance by a user and not limited to the above-described values. In a case where the results of the learning by the learning unit 505 are not stable, it may also be possible to set the number of learning rays (Nr) to a larger value. The larger the number of learning rays (Nr) is increased, the more the memory usage relating to the VRAM increases. Next, at S602, the image obtaining unit 502 obtains a plurality of pieces of captured image data (multi-viewpoint image data) obtained by the image capturing of a plurality of the imaging apparatuses 101.

Next, at S603, the area obtaining unit 503 obtains the object area in each captured image configuring the multi-viewpoint image data obtained at S602. Specifically, the area obtaining unit 503 obtains the object area in each captured image by extracting the object area from each captured image. The area obtaining unit 503 generates the object area map indicating the obtained object area for each captured image and outputs the object area map to the ray setting unit 504. For example, the area obtaining unit 503 specifies and extracts the object area in each captured image based on the difference between the captured image and the background image prepared in advance. The obtaining method of an object area in the area obtaining unit 503 is not limited to the above-described method. It is not necessarily required for the area obtaining unit 503 to obtain the object area in the captured image by using the captured image. For example, it may also be possible for the area obtaining unit 503 to obtain the object area in the captured image by obtaining the extraction results of the object area in each captured image which extracted by other external device.

Next, at S604, the ray setting unit 504 sets a group of rays (learning rays) that are used for the learning of the three-dimensional field of the image capturing space by referring to the object area map generated at S603. Specifically, the ray setting unit 504 generates a list (in the following, called “object ray list”) of the data of the learning ray (in the following, called “object ray”) corresponding to the pixel included in the object area in each captured image by referring to the object area map. Further, the ray setting unit 504 generates a list (in the following, called “non-object ray list”) of the data of the learning ray (in the following, called “non-object ray”) corresponding to the pixel included in the non-object area in each captured image by referring to the object area map.

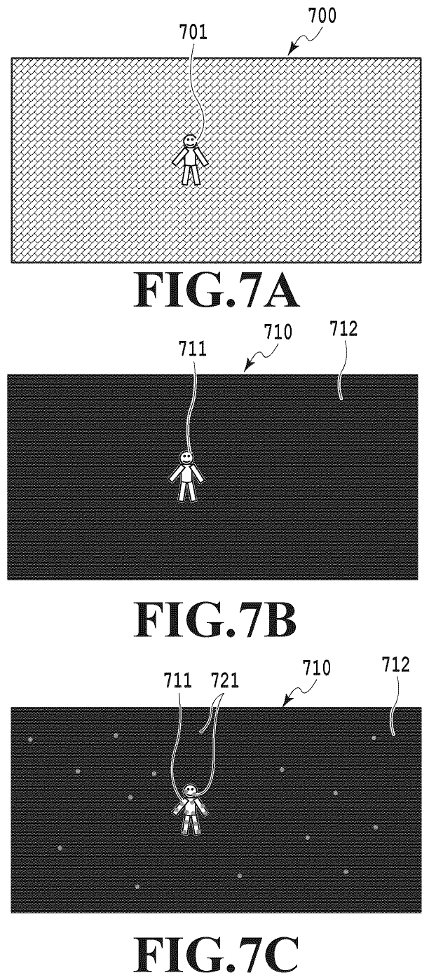

FIG. 7 is a diagram for explaining the processing at S602 to S604 shown in FIG. 6A. Specifically, FIG. 7A shows one example of a captured image 700 that is obtained by image capturing of one of the imaging apparatuses 101, that is, one example of the captured image 700 that is obtained at S602. In the captured image 700, the area of the image corresponding to the object 107, that is, an object area 701 is included. FIG. 7B shows one example of an object area map 710 corresponding to the captured image 700. In the object area map 710, an object area 711 corresponding to the object area 701 in the captured image 700 and a non-object area 712 corresponding to the area other than the object area 701 in the captured image 700 are included. FIG. 7C shows one example of the distribution of learning rays 721 corresponding to the pixels of the captured image 700. FIG. 7C shows one example of the distribution of the learning rays 721 corresponding to the captured image 700 by using an object area map 710 in place of the captured image 700.

After S604, at S605, the learning unit 505 performs learning processing for the learning model representing the three-dimensional field of the image capturing space. Specifically, first, the learning unit 505 samples the data of the Nf object rays among the data of the object rays included in the object ray list as the learning ray data for learning the learning model representing the three-dimensional field of the image capturing space. Further, the learning unit 505 samples the data of the Nb non-object rays among the data of the non-object rays included in the non-object ray list as the learning ray data for learning the learning model representing the three-dimensional field of the image capturing space. Here, Nb is the number of non-object rays and is a value obtained by subtracting the number of object rays (Nf) from the number of learning rays (Nr). Consequently, the number of pieces of learning ray data that are sampled for learning the learning model representing the three-dimensional field of the image capturing space is the number of learning rays (Nr), which is the sum of adding the number of object rays (Nf) and the number of non-object rays (Nb). Following this, the learning unit 505 performs learning of the learning model representing the three-dimensional field of the image capturing space by using the sampled learning ray data. Details of the learning processing at S605 will be described later by using FIG. 6B.

Next, at S606, the model output unit 506 outputs a learned model that is obtained as the results of the learning processing at S605. Specifically, for example, the model output unit 506 outputs a file including the network parameters of the learned model as data to the storage device 204 or the storage device 104 and causes the storage device 204 or the storage device 104 to store the file. As the format of the file, there are a variety of formats depending on the learning environment of the learning model and for example, in a case of machine learning using PyTorch, files represented by the extension, such as pt or pth, are stored in many cases. After S606, the image processing apparatus 102 terminates the processing of the flowchart shown in FIG. 6A.

### <Learning Processing in Learning Unit>

With reference to FIG. 6B, the learning processing in the learning unit 505 is explained. FIG. 6B is a flowchart showing one example of a flow of the learning processing in the learning unit 505 according to Embodiment 1 and is a flowchart showing one example of a flow of the learning processing at S605. The processing of the flowchart is performed after S604. First, at S607, the learning unit 505 performs initialization processing. Specifically, for example, the learning unit 505 performs the following processing as initialization processing. The learning unit 505 obtains the number of pieces of object ray data included in the object ray list (in the following, called “object ray list length (Lf)”) and the number of pieces of non-object ray data included in the non-object ray list (in the following, called “non-object ray list length (Lb)”). Further, the learning unit 505 sets a sampling counter (Sf) of the object ray to the object ray list length (Lf) and a sampling counter (Sb) of the non-object ray to the non-object ray list length (Lb), respectively.

Next, at S608, the learning unit 505 judges whether or not the data of all the object rays included in the object ray list has been selected (sampled). Specifically, in a case where Sf<Lf, the learning unit 505 judges that the data of at least part of the object rays included in the object ray list has not been selected (NO). Further, in a case where Sf≥Lf, the learning unit 505 judges that the data of all the object rays included in the object ray list has been selected (YES). Consequently, in the first judgement at S608, YES is judged without fail. In a case where YES is judged at S608, the learning unit 505 rearranges the data of the object rays included in the object ray list randomly at S609 and sets the sampling counter (Sf) of the object ray to 0.

After S609 or in a case where NO is judged at S608, the learning unit 505 judges, at S610, whether or not the data of all the non-object rays included in the non-object ray list has been selected (sampled). Specifically, in a case where Sb<Lb, the learning unit 505 judges that the data of at least part of the non-object rays included in the non-object ray list has not been selected (NO). On the other hand, in a case where Sb≥Lb, the learning unit 505 judges that the data of all the non-object rays included in the non-object ray list has been selected (YES). Consequently, in the first judgement at S610, YES is judged without fail. In a case where YES is judged S610, the learning unit 505 rearranges the data of the non-object rays included in the non-object ray list randomly at S611 and sets the sampling counter (Sb) of the non-object ray to 0.

After S611 or in a case where NO is judged at S610, the learning unit 505 performs the processing at S612. At S612, first, the learning unit 505 selects (samples) the data of the Nf object rays including the (Sf+1)th object ray and the subsequent object rays among the data of the object rays included in the object ray list. Following this, at S612, the learning unit 505 copies the data of the selected object rays to the learning ray list as the learning ray data. In a case where Sf+Nf>Lf, the learning unit 505 performs the following processing. Specifically, first, the learning unit 505 selects the data of the object rays including the (Sf+1)th object ray to the Lfth object ray among the data of the object rays included in the object ray list and copies the data as the learning ray data. Following this, the learning unit 505 selects the data of the object rays including the first object ray to the (Sf+Nf−Lf)th object ray located at the front portion of the object ray list and adds and copies the data as the learning ray data. After copying the data to the learning ray list, the learning unit 505 adds the number of object rays (Nf) to the sampling counter (Sf) of the object ray.

Further, following this, at S612, the learning unit 505 selects (samples) the data of the Nb non-object rays including the (Sb+1)th non-object ray and the subsequent non-object rays among the data of the non-object rays included in the non-object ray list. Following this, at S612, the learning unit 505 copies the data of the selected non-object rays to the learning ray list as the leaning ray data. In a case where Sb+Nb>Lb, the learning unit 505 performs the following processing. Specifically, first, the learning unit 505 selects the data of the non-object rays including the (Sb+1)th to the Lbth non-object rays among the data of the non-object rays included in the non-object ray list and copies the data as the learning ray data. Following this, the learning unit 505 selects the data of the non-object rays including the first to (Sb+Nb−1)th non-object rays located at the front portion of the non-object ray list and adds and copies the data as the learning ray data.

After copying the data to the leaning ray list, following this, at S612, the learning unit 505 adds the number of non-object rays (Nb) to the sampling counter (Sb) of the non-object ray. Consequently, a learning ray list length is the number of learning rays (Nr), which is the sum of adding the number of object rays (Nf) and the number of non-object rays (Nb). Further, at S612, the learning unit 505 copies the pixel values of the captured images corresponding to the data of the object rays and the data of the non-object rays respectively, which are copied to the learning ray list as the learning ray data, to a ground truth list as ground truth data.

After S612, based on the learning ray data copied to the learning ray list and the ground truth data copied to the ground truth list, the learning processing of the learning model representing the three-dimensional field of the image capturing space is performed. The processing at S608 to S612 and the learning processing of the learning model following S612 are performed repeatedly until YES is judged at S615 to be described later.

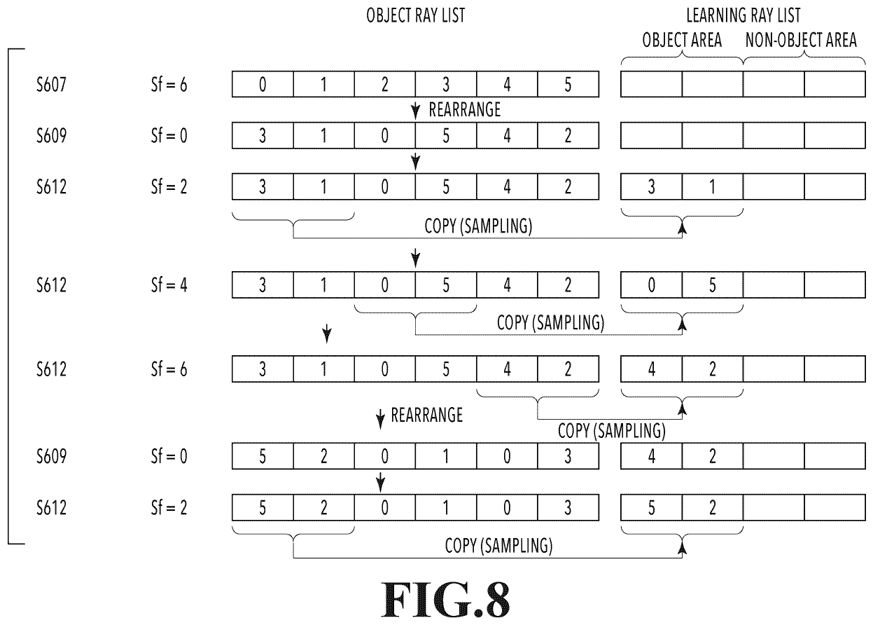

FIG. 8 is a diagram showing one example of a flow of sampling of the data of the object rays included in the object ray list according to Embodiment 1. Specifically, FIG. 8 shows, as one example, a case where the object ray list length (Lf) is 6, the learning ray list length, that is, the number of learning rays (Nr) is 4, and the number of object rays (Nf) is 2. In order to simplify explanation, in FIG. 8, the sampling of the data of the non-object rays among the learning ray list is not described.

First, by the initialization processing at S607, the data of the object rays is stored in the object ray list in order of the pixel position and the sampling counter (Sf) of the object ray is set to 6. Next, Sf≥Lf is judged at S608, and therefore, at S609, the data of the object rays included in the object ray list is rearranged randomly and the sampling counter (Sf) of the object ray is set to 0. Next, at S612, among the data of the object rays included in the object ray list, the data of the first and second object rays is copied to the learning ray list and the sampling counter (Sf) of the object ray is set to 2. After that, each time the learning processing is performed repeatedly, 2 is added to the sampling counter (Sf) of the object ray at S612. Further, in a case where the sampling counter (Sf) of object ray reaches 6, at S609, the data of the object rays included in the object ray list is rearranged again and the sampling counter (Sf) of the object ray is reset to 0. After that, the sampling in the second cycle for the object ray list is performed.

After S612, at S613, the learning unit 505 calculates the pixel value corresponding to the data of each learning ray included in the learning ray list by using the learning model representing the three-dimensional field of the image capturing space. Here, in a case where the pixel value is represented by values representing colors, such as R (Red), G (Green), and B (Blue), the learning unit 505 calculates the value of the color as the pixel value. Next, at S614, the learning unit 505 updates the network parameters of the learning model representing the three-dimensional field of the image capturing space so that the difference (loss) between the calculated pixel value and the pixel value as the ground truth data included in the ground truth list becomes smaller.

Next, at S615, the learning unit 505 judges whether or not the learning processing for the learning model representing the three-dimensional filed of the image capturing space satisfies the termination condition. In a case where it is judged that the termination condition is not satisfied (NO) at S615, the learning unit 505 returns to the processing at S608 and performs the series of processing at S608 to S615 repeatedly until it is judged that the termination condition is satisfied (YES) at S615. In a case where it is judged that the termination condition is satisfied (YES) at S615, the learning unit 505 terminates the processing of the flowchart shown in FIG. 6B, that is, the learning processing at S605. The termination condition of the learning processing is, for example, performing the learning processing for the learning model the number of times of learning, which is also called the number of iterations designated in advance. The termination condition of the learning processing is not limited to this and for example, the termination condition may be the above-described loss satisfying the convergence condition determined in advance. Further, for example, in a case where a symptom of an increase in the loss for an image for inspection prepared separately is confirmed, the termination condition of the learning processing may be judged to be satisfied.

As above, the image processing apparatus 102 is configured so that the number of pieces of learning ray data corresponding to the object area in the captured image is controlled appropriately, which is used for the learning of the learning model representing the three-dimensional field of the image capturing space. According to the image processing apparatus 102 thus configured, it is possible to perform the learning processing of the learning model representing the three-dimensional field of the image capturing space at high speed without depending on the size of the object or the viewing angle of the imaging apparatus 101. Further, according to the image processing apparatus 102 thus configured, it is possible to generate the learned model representing the three-dimensional field of the image capturing space with high accuracy without depending on the size of the object or the viewing angle of the imaging apparatus 101.

### <Operation in Generation Phase of Image Processing Apparatus>

With reference to FIG. 6C, the operation in the generation phase of the image processing apparatus 102 according to Embodiment 1 is explained. First, at S616, the model obtaining unit 507 obtains the learned model representing the three-dimensional field of the image capturing space. Specifically, the model obtaining unit 507 obtains the learned model by reading the network parameters of the learned model from the storage device 204, the storage device 104 or the like. Next, at S617, the viewing obtaining unit 508 obtains virtual viewpoint information. Next, at S618, the image generation unit 509 generates a virtual viewpoint image by using the learned model obtained at S616 and the virtual viewpoint information obtained at S617. Specifically, the image generation unit 509 inputs information indicating the position of a virtual viewpoint and information indicating the viewing direction at the virtual viewpoint, which are included in the virtual viewpoint information, to the learned model. The learned model calculates the pixel value of the virtual viewpoint image based on the ray in accordance with the position of the virtual viewpoint and the viewing direction at the virtual viewpoint and outputs the calculated pixel value. The image generation unit 509 generates the virtual viewpoint image by obtaining the pixel value that is output from the learned model and configuring the virtual viewpoint image having the pixel value.

Next, at S619, the image output unit 510 outputs the data of the virtual viewpoint image generated at S618 or the image signal for displaying the virtual viewpoint image to the storage device 204, the storage device 104, or the display device 105. After S619, the image processing apparatus 102 terminates the processing of the flowchart shown in FIG. 6C. In a case where the image generation unit 509 generates a moving image as a virtual viewpoint image, such as a case where the virtual viewpoint information is a virtual camera path, the image processing apparatus 102 performs the processing of the flowchart shown in FIG. 6C repeatedly.

As above, the image processing apparatus 102 is configured so that the number of pieces of learning ray data corresponding to the object area in the captured image is controlled appropriately, which is used for the learning of the learning model representing the three-dimensional field of the image capturing space. Further, the image processing apparatus 102 is configured so that the virtual viewpoint image is generated by using the learned model, which is obtained as the results of the learning such as this and with which the three-dimensional field of the image capturing space is represented with high accuracy. According to the image processing apparatus 102 configured as above, it is possible to generate a virtual viewpoint image of high accuracy without depending on the occupied area ratio of the object area in the captured image, which is used for learning.

### Embodiment 2

In Embodiment 1, the aspect is explained in which the image area in the captured image is divided into the object area and the non-object area and the learning ray data corresponding to each pixel is selected (sampled) based on these areas. In Embodiment 2, an aspect is explained in which the learning of a learning model representing the three-dimensional field of an image capturing space is performed more efficiently by dividing the image area in a captured image into the learning area and the non-learning area. In Embodiment 2, processing different from the processing explained in Embodiment 1 is explained mainly and explanation of the same processing is omitted.

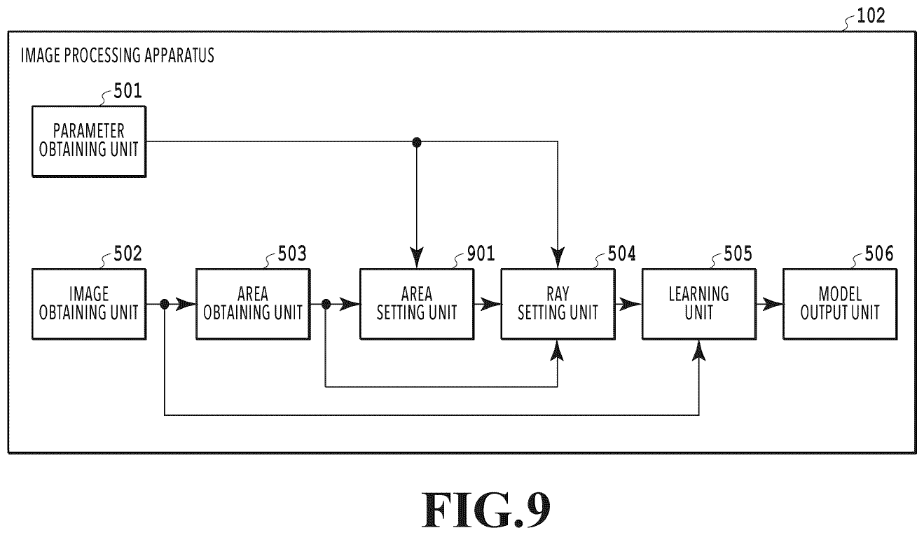

FIG. 9 is a block diagram showing one example of the function configuration of the image processing apparatus 102 according to Embodiment 2 (in the following, simply described as “image processing apparatus 102”). The image processing apparatus 102 differs from the image processing apparatus 102 according to Embodiment 1 in having an area setting unit 901. The area setting unit 901 obtains the object area map that is output from the area obtaining unit 503 and sets the learning area and the non-learning area in a captured image based on the obtained object area map. Information indicating the learning area (in the following, called “learning area information”) in the captured image, which is set by the area setting unit 901, is output to the ray setting unit 504. The ray setting unit 504 obtains the learning area information that is output from the area setting unit 901 and the object area map that is output from the area obtaining unit 503. The ray setting unit 504 sets a learning ray group that is used for the learning of the three-dimensional field of an image capturing space based on the learning area information and the object area map, which are obtained.

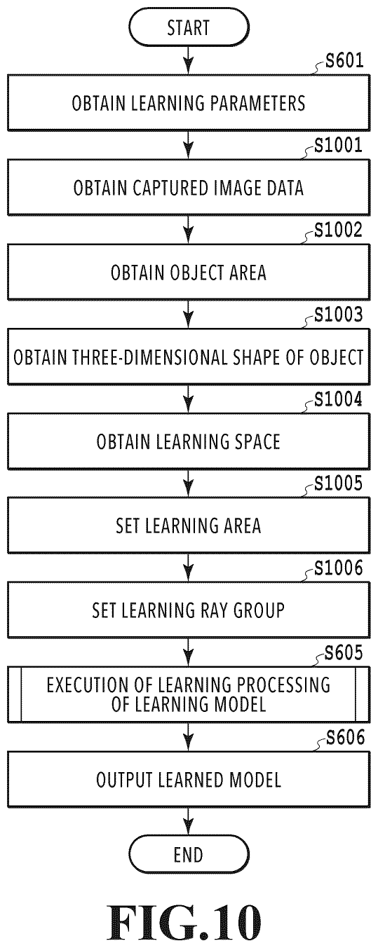

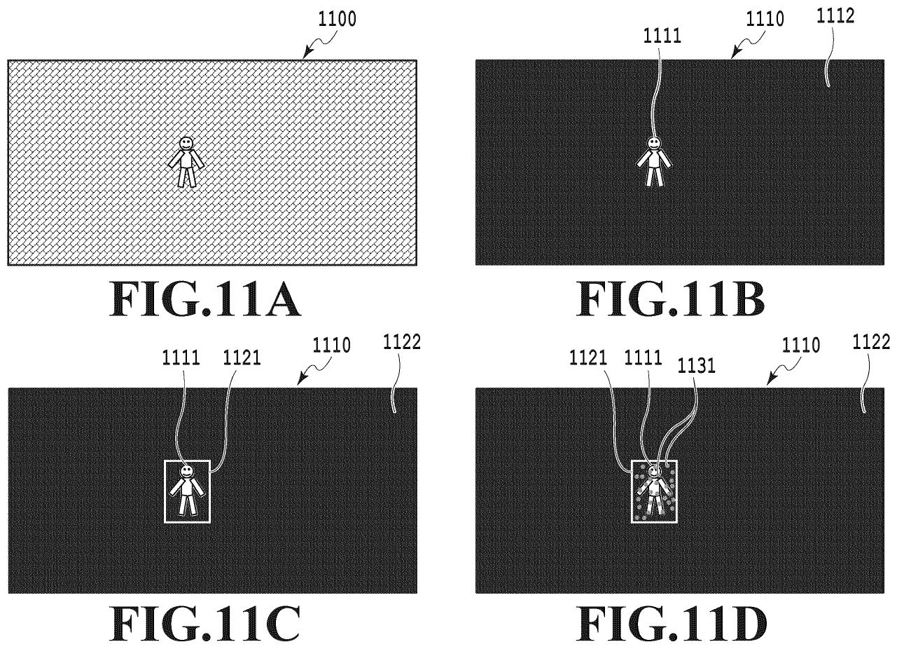

FIG. 10 is a flowchart showing one example of a processing flow in the learning phase of the image processing apparatus 102 according to Embodiment 2. FIG. 11A to FIG. 11D are diagrams for explaining the processing of the flowchart shown in FIG. 10.

Among the steps of the processing shown in FIG. 10, to the step at which the same processing as that at the step shown in FIG. 6A is performed, the same symbol is attached and explanation thereof is omitted. First, the image processing apparatus 102 performs the processing at S601.

After S601, at S1001, the image obtaining unit 502 obtains a plurality of pieces of captured image data (multi-viewpoint image data) obtained by image capturing of a plurality of the imaging apparatuses 101. For example, the image obtaining unit 502 obtains the data of an α-channel data-attached captured image as the captured image data. For example, in the α-channel, the α-value is set to 1 for the object area in the captured image and the α-value is set to 0 for the non-object area. The α-value is not limited to the two values of 1 or 0, and for example, in the vicinity of the contour of the object area, a halftone α-value, such as 0.5, may be set. FIG. 11A is a captured image 1100, which is the same as the captured image 700 shown in FIG. 7A. However, to the data of the captured image 1100, α-channel data is attached.

Next, at S1002, the area obtaining unit 503 obtains the object area in each captured image obtained at S1001. Specifically, the area obtaining unit 503 extracts the α-channel data from the α-channel data-attached captured image and outputs the extracted α-channel data as the object area map indicating the object area in the captured image. FIG. 11B is one example of an object area map 1110 that is output at S1002, showing one example of the object area map 1110 corresponding to the captured image 1100 obtained at S1001. The object area map 1110 shows an object area 1111 and a non-object area 1112 by two values.

After S1002, the area setting unit 901 performs the series of processing at S1003 to S1005 and sets the learning area and the non-learning area in the captured image obtained at S1001. Specifically, at S1003, the area setting unit 901 obtains the object area map corresponding to each captured image, which is output at S1002, and obtains the three-dimensional shape of the object 107 by the visual hull method by using a plurality of the obtained object area maps. The visual hull method is the well-known technique, and therefore, explanation is omitted. Next, at S1004, the area setting unit 901 obtains the learning space in the image capturing space 106 based on the three-dimensional shape of the object 107 obtained at S1003. Specifically, for example, the area setting unit 901 obtains a circumscribed sphere or a circumscribed polyhedron such as a circumscribed rectangular parallelepiped, which contains the three-dimensional shape of the object 107 obtained at S1003 as the learning space.

Next, at S1005, the area setting unit 901 projects the learning space obtained at S1004 onto the position of each imaging apparatus 101, that is, onto each viewpoint and sets the area in which the projection of the learning space in each captured image intersects as the learning area. Further, the area setting unit 901 sets the area in which the projection of the learning space in each captured image does not intersect as the non-learning area. FIG. 11C shows one example of a learning area 1121 and a non-learning area 1122 in the captured image 1100. FIG. 11C shows one example of the learning area 1121 and the non-learning area 1122 in the captured image 1100 by using the object area map 1110 in place of the captured image 1100.

Next, at S1006, the ray setting unit 504 sets a group of rays (learning rays) to be used for the learning of the three-dimensional field of the image capturing space by referring to the object area map output at S1002 and the learning area set at S1005. Specifically, the ray setting unit 504 generates a list (object ray list) of the data of learning rays (object rays) corresponding to each pixel group included in the object area in each captured image by referring to the object area map. Further, the ray setting unit 504 generates a list (non-object ray list) of the data of learning rays (non-object rays) corresponding to the pixel group included in the non-object area in the learning area of each captured image by referring to the object area map and the learning area.

That is, the ray setting unit 504 generates the non-object ray list so that the data of the learning rays corresponding to the pixel group included in the non-learning area is not included in the non-object ray list. FIG. 11D shows one example of the distribution of learning rays 1131 corresponding to the pixels of the captured image 1100. FIG. 11D shows one example of the distribution of the learning rays 1131 corresponding to the captured image 1100 by using the object area map 1110 in place of the captured image 1100.

Next, at S605, the learning unit 505 performs learning processing for a learning model representing the three-dimensional field of the image capturing space. The processing at S605 according to Embodiment 2 is the same as the processing at S605 according to Embodiment 1, and therefore, a detailed explanation is omitted. Next, at S606, the model output unit 506 outputs a learned model. The processing at S606 according to Embodiment 2 is the same as the processing at S606 according to Embodiment 1, and therefore, a detailed explanation is omitted. After S606, the image processing apparatus 102 terminates the flowchart shown in FIG. 10.

According to the image processing apparatus 102 configured as above, by setting the non-learning area in the captured image, it is possible to efficiently delete learning rays unnecessary for the learning of the learning model representing the three-dimensional field of the image capturing space. As a result, according to the image processing apparatus 102, it is possible to perform the learning of the learning model at a higher speed.

The above-described explanation is given on the assumption that the non-object ray list is generated so that the data of the learning rays corresponding to the pixels included in the non-learning area is not included in the non-object ray list, but explanation is not limited to this. For example, it may also be possible for the ray setting unit 504 to generate the non-object ray list so that the data of the learning rays corresponding to the pixels included in the non-learning area is included in the non-object ray list like the ray setting unit 504 according to Embodiment 1. In this case, it is sufficient for the learning unit 505 not to sample the data of the non-object rays corresponding to the pixels included in the non-learning area among the data of the non-object rays included in the non-object ray list in performing the learning processing.

### Embodiment 3

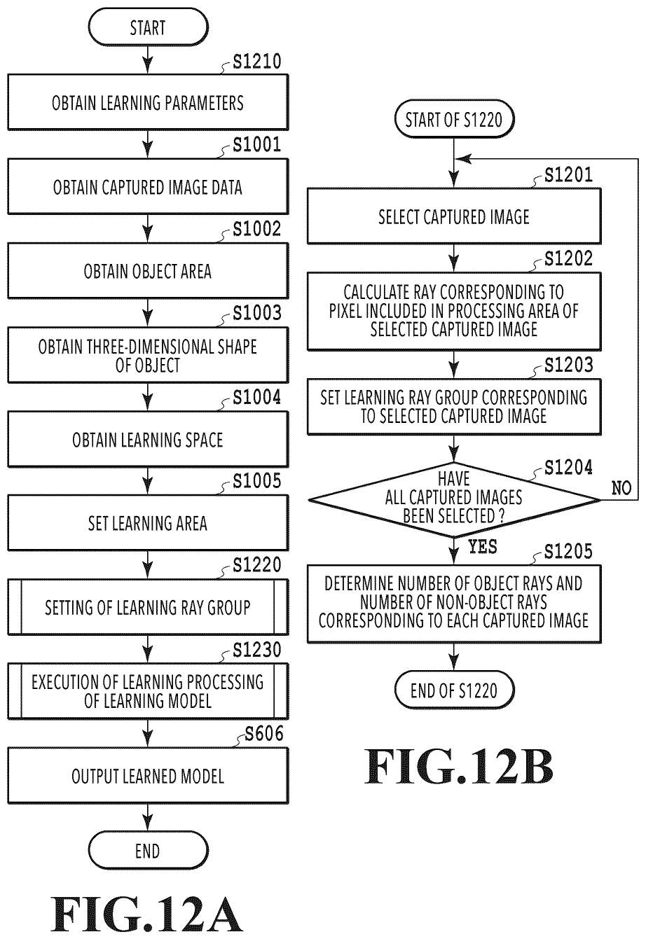

In Embodiment 1 and Embodiment 2, the aspect is explained in which the number of learning rays (Nr) and the number of object rays (Nf), which are determined in advance, are obtained as the learning parameters and sampling of the object rays and the non-object rays is performed. In Embodiment 3, an aspect is explained in which the number of object rays is determined in accordance with each captured image. With reference to FIG. 12A and FIG. 12B, the operation of the image processing apparatus 102 according to Embodiment 3 is explained. The function configuration of the image processing apparatus 102 according to Embodiment 3 is the same as the function configuration of the image processing apparatus 102 according to Embodiment 2 shown in FIG. 9 as one example, and therefore, a detailed explanation is omitted.

FIG. 12A and FIG. 12B are each a flowchart showing one example of a processing flow of the image processing apparatus 102 according to Embodiment 3 (in the following, simply described as “image processing apparatus 102”). Among the steps of the processing shown in FIG. 12A and FIG. 12B, to the step at which the same processing as that at the step shown in FIG. 6A or FIG. 10 is performed, the same symbol is attached and explanation is omitted. First, at S1210, the parameter obtaining unit 501 obtains learning parameters.

Specifically, the parameter obtaining unit 501 obtains an object ray ratio lower limit value (Rfₘᵢₙ) indicating a lower limit value of the ratio of the number of object rays (Nf) to the number of learning rays (Nr) and an object ray ratio upper limit value (Rfₘₐₓ) indicating an upper limit value of the ratio. The parameter obtaining unit 501 may obtain the number of learning rays (Nr), a lower limit number of object rays (Nfₘᵢₙ) indicating a lower limit value of the number of object rays, and an upper limit number of object rays (Nfₘₐₓ) indicating an upper limit value of the number of object rays. In this case, it is possible for the parameter obtaining unit 501 to obtain the object ray ratio lower limit value (Rfₘᵢₙ) by dividing the lower limit number of object rays (Nfₘᵢₙ) by the number of learning rays (Nr). Further, it is possible for the parameter obtaining unit 501 to obtain the object ray ratio upper limit value (Rfₘₐₓ) by dividing the upper limit number of object rays (Nfₘₐₓ) by the number of learning rays (Nr).

After S1210, the image processing apparatus 102 performs the series of processing at S1001 to S1005. After S1005, at S1220, the ray setting unit 504 sets a group of rays (learning rays) to be used for the learning of the three-dimensional field of an image capturing space by referring to the object area map output at S1002 and the learning area set at S1005. Details of setting processing of the learning ray group at S1220 will be described later by using FIG. 12B. After S1220, at S1230, the learning unit 505 performs learning processing for a learning model representing the three-dimensional field of the image capturing space. Details of the learning processing at S1230 will be described later. After S1230, the image processing apparatus 102 performs the processing at S606. After S606, the image processing apparatus 102 terminates the processing of the flowchart shown in FIG. 12A.

FIG. 12B is a flowchart showing one example of a flow of setting processing of the learning ray group in the ray setting unit 504 according to Embodiment 3 and is a flowchart showing one example of a flow of the setting processing of the learning ray group at S1220. The processing of the flowchart is performed after S1005. First, at S1201, the ray setting unit 504 selects an arbitrary captured image from among the plurality of captured images obtained at S1001. Next, at S1202, the ray setting unit 504 calculates the learning ray corresponding to the pixel included in the learning area in the captured image selected at S1201 by referring to the learning area set at S1005.

Next, at S1203, the ray setting unit 504 generates an object ray list and a non-object ray list, which correspond to the captured image selected at S1201, based on the object area obtained at S1002 and the learning ray calculated at S1202. Further, at S1203, the ray setting unit 504 obtains a list length of the generated object ray list (object ray list length (Lfᵢ)) and a list length of the generated non-object ray list (non-object ray list length (Lbᵢ)). Here, “i” included in Lfᵢ and Lbᵢ indicates the index of the captured image selected at S1201.

Next, at S1204, the ray setting unit 504 judges whether or not all the captured images have been selected at S1201. In a case where it is judged that at least part of the captured images have not been selected at S1204, the ray setting unit 504 returns to the processing at S1201 and performs the processing at S1201 to S1204 repeatedly until it is judged that all the captured images have been selected at S1204. In a case where the processing at S1201 to S1204 is repeated, at S1201, the ray setting unit 504 selects an arbitrary captured image from among one or more captured images not having been selected yet among the plurality of captured images.

In a case where it is judged that all the captured images have been selected at S1204, the ray setting unit 504 performs the processing at S1205. Specifically, at S1205, the ray setting unit 504 calculates a number of object rays (Nfᵢ) and a number of non-object rays (Nbᵢ) of each captured image from the object ray list length (Lfᵢ)) and the non-object ray list length (Lbᵢ), which correspond to each captured image. For example, the number of object rays (Nfᵢ) and the number of non-object rays (Nbᵢ) of each captured image may be calculated by using formula (1) to formula (5) below.

$${L}_{i} = Σ {Lf}_{i} + Σ {Lb}_{i} \qquad formula ( 1 )$$

$${Rf}_{i} = ( Σ {Lf}_{i} ) / {L}_{i} \qquad formula ( 2 )$$

$${Rf}_{i}^{′} = min ( max ( {Rf}_{i} , {Rf}_{min} ) , {Rf}_{max} ) \qquad formula ( 3 )$$

$${Nf}_{i} = {L}_{i} \cdot {Rf}_{i}^{′} \qquad formula ( 4 )$$

$${Nb}_{i} = {L}_{i} \cdot ( 1 - {Rf}_{i}^{′} ) \qquad formula ( 5 )$$

Here, Lᵢ is the number of candidates of the learning ray and Rfᵢ is the ratio of the number of object rays to the number of candidates of the learning ray (Lᵢ). Then, max ( ) is the max function and min ( ) is the minimum function. Rfᵢ′ is the value obtained by applying the object ray ratio upper limit value (Rfₘₐₓ) and the object ray ratio lower limit value (Rfₘᵢₙ) to the ratio (Rfᵢ) of the number of object rays to the number of candidates of the learning ray (Lᵢ). Nfᵢ is the number of object rays to be sampled for each captured image and Nbᵢ is the number of non-object rays to be sampled for each captured image.

After S1205, the ray setting unit 504 terminates the processing of the flowchart shown in FIG. 12B, that is, the processing at S1220 shown in FIG. 12A. After S1220, at S1230, the learning unit 505 performs learning processing for the learning model representing the three-dimensional field of the image capturing space by using the number of object rays (Nfᵢ) and the number of non-object rays (Nbᵢ) of each captured image, which are calculated at S1205. Specifically, the learning unit 505 performs the processing of the flowchart by replacing the number of object rays (Nf) in the processing of the flowchart shown in FIG. 6B with the number of object rays (Nfᵢ) corresponding to the captured image for each captured image. Similarly, the learning unit 505 performs the processing of the flowchart by replacing the number of non-object rays (Nb) in the processing of the flowchart shown in FIG. 6B with the number of non-object rays (Nbᵢ) corresponding to the captured image for each captured image.

According to the image processing apparatus 102 configured as above, it is possible to suppress the disbalance of the learning accompanying the extreme disbalance of the ratio between captured images while maintaining the learning in accordance with the occupied area ratio of the object area for each captured image. Further, according to the image processing apparatus 102, it is also possible to perform the learning of the object area without omission for a specific captured image whose ratio of the object ratio is low. As a result, according to the image processing apparatus 102 configured as above, compared to the case where the learning ray is sampled randomly from the entire captured image, it is possible to obtain more stable learning results. That is, according to the image processing apparatus 102 configured as above, it is possible to generate a learned model representing the three-dimensional field of an image capturing space with high accuracy without depending on the size of the object or the viewing angle of the imaging apparatus 101. Further, according to the image processing apparatus 102 configured as above, it is possible to generate a virtual viewpoint image of high accuracy without depending on the occupied area ratio of the object area in the captured image, which is used for learning.

### Other Modification Examples

### <Object Area Extraction>

The extraction method of an object area in a captured image may be a method utilizing another method, such as a method using the grabCut algorithm or a method using a learned model for extracting an object, which is obtained as a result of machine learning.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

According to the present disclosure, it is possible to estimate the three-dimensional field corresponding to an object with high accuracy, which is used in a case where a virtual viewpoint image is generated, irrespective of the occupied area ratio of an object for the viewing angle of a captured image.

This application claims priority to Japanese Patent Application No. 2023-215803, filed on Dec. 21, 2023, which is hereby incorporated by reference wherein in its entirety.

What is claimed is:

1. An image processing apparatus comprising:
one or more hardware processors; and
one or more memories storing one or more programs configured to be executed by the one or more hardware processors, the one or more programs including instructions for:
obtaining data of a plurality of captured images obtained by image capturing from a plurality of viewpoints;
obtaining an object area corresponding to a representation of an object in each of the plurality of captured images;
setting a learning ray group corresponding to pixels of each of the plurality of captured images, which is used for learning of information relating to a three-dimensional field of an image capturing space that is an image capturing target from the plurality of viewpoints, based on the obtained object area; and
performing learning of information relating to the three-dimensional field based on the set learning ray group.

2. The image processing apparatus according to claim 1, wherein
the one or more programs further include instructions for:
controlling the number of selections of the learning ray corresponding to the object area in a case where a learning ray that is used for learning of information relating to the three-dimensional field is selected from among the learning ray group.

3. The image processing apparatus according to claim 1, wherein
the one or more programs further include instructions for:
obtaining information relating to the number of selections of the learning ray as learning parameters in a case where a learning ray that is used for learning of information relating to the three-dimensional field is selected from among the learning ray group.

4. The image processing apparatus according to claim 3, wherein
the one or more programs further include instructions for:
obtaining the number of selections of the learning ray corresponding to the object area as the learning parameters in a case where a learning ray that is used for learning of information relating to the three-dimensional field is selected from among the learning ray group; and
selecting the learning ray based on the number of selectins of the learning ray corresponding to the object area obtained as the learning parameters in a case where the learning ray that is used for learning of information relating to the three-dimensional field is selected from among the set learning ray group.

5. The image processing apparatus according to claim 3, wherein
the one or more programs further include instructions for:
obtaining a ratio of the learning rays corresponding to the object area as the learning parameters;
determining the number of selections of the learning ray corresponding to the object area in a case where the learning ray that is used for learning of information relating to the three-dimensional field is selected based on the obtained ratio; and
selecting the learning ray that is used for learning of information relating to the three-dimensional field based on the determined number of selections of the learning ray.

6. The image processing apparatus according to claim 2, wherein
the one or more programs further include instructions for:
determining the number of selections of the learning ray corresponding to the object area based on a ratio between the number of pixels included in the object area and the number of pixels included in a non-object area that is the area other than the object area in each of the plurality of captured images.

7. The image processing apparatus according to claim 5, wherein
the one or more programs further include instructions for:
obtaining at least one of a lower limit value and an upper limit value of the number of selections of the learning ray corresponding to the object area as the learning parameters in a case where the learning ray that is used for learning of information relating to the three-dimensional field is selected; and
determining the number of selections of the learning ray corresponding to the object area in a case where the learning ray that is used for learning of information relating to the three-dimensional field is selected based on at least the obtained one of the lower limit value and the upper limit value.

8. The image processing apparatus according to claim 1, wherein
the one or more programs further include instructions for:
determining the number of selections of the learning ray corresponding to the object area in a case where a learning ray that is used for learning of information relating to the three-dimensional field is selected from among the set learning ray group for each captured image in the plurality of captured images.

9. The image processing apparatus according to claim 1, wherein
the one or more programs further include instructions for:
setting a learning area in each of the plurality of captured images;
selecting a learning ray that is used for learning of information relating to the three-dimensional field from among the learning ray group corresponding to the learning area; and
performing learning of information relating to the three-dimensional field by using the selected learning ray.

10. The image processing apparatus according to claim 1, wherein
the one or more programs further include instructions for:
setting a learning area in each of the plurality of captured images;
setting the learning ray group corresponding to pixels included in the learning area; and
performing learning of information relating to the three-dimensional field based on the set learning ray group.

11. The image processing apparatus according to claim 9, wherein
the one or more programs further include instructions for:
obtaining learning area information indicating the learning area in each of the plurality of captured images; and
setting the learning area in each of the plurality of captured images based on the learning area information.

12. The image processing apparatus according to claim 9, wherein
the one or more programs further include instructions for:
setting the learning area in each of the plurality of captured images by calculating the learning area in each of the plurality of captured image based on the object area in each of the plurality of captured images.

13. The image processing apparatus according to claim 1, wherein
the one or more programs further include instructions for:
obtaining virtual viewpoint information including at least viewpoint position information indicating a position of a virtual viewpoint and viewing direction information indicating a viewing direction at the virtual viewpoint; and
generating a virtual viewpoint image corresponding to the virtual viewpoint based on the obtained virtual viewpoint information and information relating to the three-dimensional field obtained as results of the learning.

14. An image processing method comprising the steps of:
obtaining data of a plurality of captured images obtained by image capturing from a plurality of viewpoints;
obtaining an object area corresponding to a representation of an object in each of the plurality of captured images;
setting a learning ray group corresponding to pixels of each of the plurality of captured images, which is used for learning of information relating to a three-dimensional field of an image capturing space that is an image capturing target from the plurality of viewpoints, based on the obtained object area; and
performing learning of information relating to the three-dimensional field based on the set learning ray group.

15. A non-transitory computer readable storage medium storing a program for causing a computer to perform a control method of an image processing apparatus, the control method comprising the steps of:
obtaining data of a plurality of captured images obtained by image capturing from a plurality of viewpoints;
obtaining an object area corresponding to a representation of an object in each of the plurality of captured images;
setting a learning ray group corresponding to pixels of each of the plurality of captured images, which is used for learning of information relating to a three-dimensional field of an image capturing space that is an image capturing target from the plurality of viewpoints, based on the obtained object area; and
performing learning of information relating to the three-dimensional field based on the set learning ray group.
